(19) United States
(12) Patent Application Publication
(10) Pub. No.: US 2023/0369622 A1
(43) Pub. Date: Nov. 16, 2023

(54) FUEL CELL MEMBRANE ELECTRODE ASSEMBLY, AND FUEL CELL

(71) Applicant: Greenerity GmbH, Alzenau (DE)

(72) Inventors: Jens-Peter Suchsland, Alzenau (DE); Jozsef Speder, Frankfurt am Main (DE); Alessandro Ghielmi, Frankfurt am Main (DE)

(21) Appl. No.: 18/031,028

(22) PCT Filed: Oct. 7, 2021
(86) PCT No.: PCT/EP2021/077748

§ 371 Date: Apr. 10, 2023

(30) Foreign Application Priority Data
Oct. 13, 2020 (DE) 10 2020 126 794.0

(51) Int. Cl. H01M 8/1004; H01M 4/86; H01M 4/90

(52) U.S. Cl. CPC H01M 8/1004; H01M 4/8668; H01M 4/9058

(57) ABSTRACT

A fuel cell membrane-electrode assembly includes a support material including a ceramic material and iridium oxide, wherein a weight fraction of iridium oxide, based on metallic iridium, with respect to the total weight of the support material, is at most 50 wt%, and the support material has a weight loss of less than 3 wt%, based on the weight fraction of the iridium oxide on exposure of the support material to a 3.3 vol% hydrogen stream in argon at a temperature of 80° C. for 12 hours.

### TECHNICAL FIELD

This disclosure relates to a fuel cell membrane-electrode assembly and a fuel cell with improved cell reversal tolerance.

### BACKGROUND

During operation of a fuel cell, it is possible on the anode of a membrane-electrode assembly (hereinafter: MEA), in the event of an insufficient quantity of fuel and simultaneous retrieval of a certain current, for high potentials to occur, thereby reversing the voltage of the fuel cell. This phenomenon is commonly referred to as “fuel depletion” or “cell reversal.” Of these high potentials, the carbon of the anode catalyst used typically in the anodes as support material for Pt-based catalysts undergoes oxidation (corrosion) and the MEA degrades.

To solve this problem, various procedures have been described. It is possible, for example, to use highly graphitized carbons as support material for the platinum catalyst, featuring a higher corrosion stability than non-graphitized carbons. It is also possible for the anode to contain, in addition to the hydrogen oxidation catalyst (HOR: hydrogen oxidation reaction), a catalyst composition for evolving oxygen (OER: oxygen evolution reaction) to provide the retrieved current through the oxidation of water to oxygen and so to protect the carbon against oxidation. Although the measures described already improve the “cell reversal tolerance” (CRT), those measures are not enough to achieve the required cell reversal tolerance. If the fuel depletion occurs too frequently or too regularly, the carbon of the anode catalyst may still corrode, the MEA may fail, and hence the entire fuel cell may drop out. Furthermore, the OER catalyst, commonly based on IrO₂, on repeated cycling between low and high potentials at the anode, of the kind occurring under cell reversal conditions or when the fuel cells are started up under air-air conditions (“air-air starts”), may tend to break down and so lose the capacity to protect the anodes.

Besides the measures above, carbon-free electrodes have likewise been proposed to improve the corrosion stability. In those instances, platinum catalyst particles may be present on a nonconductive support material such as titanium dioxide, and the anode additionally comprises a finely dispersed, conductive ceramic to ensure sufficient conductivity. One system of this kind is proposed in WO 2019/160985 A1, for example. However, those conductive ceramics used as support material or as additive do not have sufficient corrosion stability and they tend to break down especially in the highly acidic environment of a fuel cell. This results in severe power losses and, under certain circumstances, in contamination of the MEA.

It could therefore be helpful to provide a fuel cell membrane-electrode assembly and a fuel cell which combine high power density, high long-term stability and also simplicity and reliability of production with high cell reversal tolerance.

### SUMMARY

We provide a fuel cell membrane-electrode assembly including a support material including a ceramic material and iridium oxide, wherein a weight fraction of iridium oxide, based on metallic iridium, with respect to the total weight of the support material, is at most 50 wt%, and the support material has a weight loss of less than 3 wt%, based on the weight fraction of the iridium oxide on exposure of the support material to a 3.3 vol% hydrogen stream in argon at a temperature of 80° C. for 12 hours.

We also provide a fuel cell including the fuel cell membrane-electrode assembly including a support material including a ceramic material and iridium oxide, wherein a weight fraction of iridium oxide, based on metallic iridium, with respect to the total weight of the support material, is at most 50 wt%, and the support material has a weight loss of less than 3 wt%, based on the weight fraction of the iridium oxide on exposure of the support material to a 3.3 vol% hydrogen stream in argon at a temperature of 80° C. for 12 hours.

### BRIEF DESCRIPTION OF THE DRAWINGS

FIG. 1 shows a fuel cell MEA according to a first example in section.

FIG. 2 shows a support material of the fuel cell from FIG. 1.

FIG. 3 shows a fuel cell MEA according to a second example in section.

List of Reference Signs

| | |
|---|---|
| 1 | fuel cell MEA |
| 2 | cathode |
| 3 | membrane |
| 4 | anode |
| 5 | support material |
| 6 | ceramic material |
| 7 | surface of the ceramic material |
| 8 | Iridium oxide |
| 9 | hydrogen oxidation catalyst |
| 10 | fuel cell MEA |
| 11 | barrier layer |
| 12 | gas diffusion layer |
| 13 | polymeric binder |
| 14 | ionomer |

### DETAILED DESCRIPTION

Our fuel cell membrane-electrode assembly (fuel cell MEA) comprises a specific support material. The support material comprises a ceramic material and a weight fraction of iridium oxide, based on metallic iridium, further based on the total weight of the support material, of at most 50 wt%, the ceramic material being present more particularly in the form of particles or fibers. The iridium oxide may optionally take the form of a mixture with other oxides (such as iridium oxide) and is deposited in particular on the ceramic material. The iridium oxide exhibits stability toward reduction in hydrogen, characterized by a weight loss of the support material of less than 3 wt%, based on the weight fraction of the iridium oxide present, in a hydrogen atmosphere.

The reduction stability of the catalyst is determined by measurement of the loss of mass or loss of weight of the OER catalyst on exposure to a hydrogen flow at elevated temperature. This is done by performing a thermogravimetric analysis (TGA) in a reductive atmosphere. The thermogravimetric analysis of the OER catalyst powder is performed by a Mettler Toledo TGA/DSC 1 apparats. About 10 to 12 mg of the OER catalyst powder are weighed into an α-alumina crucible (volume: 70 µL), which is closed with a perforated α-alumina lid, and are introduced directly into the TGA oven. All of the gases used in the thermogravimetric analysis are of 5.0 purity and are sold by Westfalen AG. Argon (20 mLmin⁻¹) is used here as cell carrier gas additionally to hydrogen.

Each TGA measurement breaks down into steps as follows:
i) in situ drying step in oxidizing atmosphere and
ii) metal oxide reduction step in reducing atmosphere.

The in situ drying step is used to desorb all of the organic molecules and water molecules adsorbed on the surface of the OER catalyst powder so that the weight loss in step ii) is attributable solely to the reduction of iridium oxide.

The procedure for the in situ drying step is as follows: first the TGA oven is purged with argon for 5 min at a temperature of 25° C. (100 mLmin⁻¹), after which the temperature is raised from 25 to 200° C. (10 Kmin⁻¹) in O₂ (100 mLmin⁻¹). The temperature of 200° C. is held for 10 min in O₂ (100 mLmin⁻¹). The oven is subsequently cooled down from 200 to 25° C. (-10 Kmin⁻¹) in O₂ (100 mLmin⁻¹) and lastly the TGA oven is purged with argon (100 mLmin⁻¹) for 5 min at 25° C.

During the metal oxide reduction step ii), the oven is heated from 25° C. to 80° C. at a heating rate of 5 Kmin⁻¹ in argon (100 mLmin⁻¹), followed by a gas switch to 3.3 vol% H₂/Ar (40 mLmin⁻¹) and maintenance of 80° C. for 12 hours. The oven is thereafter cooled from 80° C. to 25° C. (cooling rate: -20 Kmin⁻¹) in Ar (100 mLmin⁻¹).

If, for example, the support material comprises 30 wt% IrO₂, the weight loss of the support material in H₂ is less than 0.9 wt%, on the proviso that the ceramic material is selected such that it exhibits approximately no weight loss under these conditions. The reduction stability of the iridium oxide in the hydrogen surroundings is achieved by a heat treatment, in other words a thermal conditioning of the support material at sufficiently high temperatures of more than 400° C., preferably more than 450° C. and more preferably more than 500° C.

According to one configuration, the support material is present in an anode of the fuel cell membrane-electrode assembly and the anode further comprises at least one ionomer and a hydrogen oxidation catalyst, the hydrogen oxidation catalyst comprising particles of platinum and/or a platinum alloy which are disposed on the support material. The hydrogen oxidation catalyst is disposed more particularly on the surface of the support material, with the hydrogen oxidation catalyst and the ionomer being very thoroughly mixed. In this example, the hydrogen oxidation catalyst may be disposed on the iridium oxide and/or on the ceramic material.

The arrangement above results in a high power density. It is a result in particular of a very fine distribution of the particles of platinum and/or platinum alloy of the hydrogen oxidation catalyst on the support material of iridium oxide and the ceramic material, producing good utilization of platinum.

Alternatively or additively, the carrier material is present in a barrier layer which is disposed between an anode and a gas diffusion layer of the fuel cell membrane-electrode assembly, the barrier layer further comprising at least one polymeric binder. Due to the use of the specific support material, the barrier layer is notable for outstanding and reliable producibility, high functionality, in particular a high long-term stability, and low costs, and enables excellent cell reversal tolerance on the part of the fuel cell MEA.

In the observations described above, the use of a stable iridium oxide is especially important, this oxide neither dissolving nor suffering any detraction from the OER properties on repeated potential cycling of the anode between low and high potentials. The stability is achieved by heat treatment of the support material at high temperatures, providing the iridium oxide with stability toward reduction by hydrogen. As well as improving the stability, the heat treatment of the iridium oxide additionally produces a reduction in the OER activity as a result both of the reduction in surface area and of the reduction in surface activity as a result of change in the crystal structure. However, in light of the fact that there are substantially no carbon-based materials present in the layer in which the support material is employed, the cell reversal tolerance is excellent, this being even when the OER activity of the iridium oxide does not achieve the maximum possible level. In other words, the durable retention of the activity of the iridium oxide, i.e., the long-term stability of the iridium oxide, is more important than the initial OER activity of the iridium oxide since the anode and/or the barrier layer are substantially free from carbon and/or carbon-containing supports. “Substantially free from carbon and/or carbon-containing supports” means that no carbon or carbon-containing compounds are added to the anode and/or to the barrier layer. Commonly the carbon-containing supports are not polymeric compounds.

In the absence of carbon materials, the electrical conductivity of the layers is ensured by the metals or metal oxides, more particularly by iridium oxide and the platinum in the anode layer, and also the iridium oxide in the barrier layer. Consequently, no electrically conductive carbon-containing materials such as carbon black or graphite, for example, are employed in either the anode or any barrier layer present. To achieve effective conductivity and, correspondingly, high performance capacity on the part of the cell, the metal content in terms of electrically conductive metal compounds, based on the total weight of the constituents of the layer (weight ratio of the sum of the metals to the sum of metals, oxides and ceramic materials), ought to be sufficiently large, and ought to be at least 15 wt% and preferably at least 30 wt%.

The support material for producing the anode and also the support material for producing the barrier layer are characterized by the same properties as described above, but may exhibit different parameters within a fuel cell MEA such as in respect of the weight fraction of iridium, the crystallinity of the iridium compound, the chemical composition of the ceramic material, or the BET surface area of the ceramic material, for example.

In the fuel cell MEA, as already stated above, a high cell reversal tolerance is achieved, this being due in particular to the fact that there are no carbon materials in the anode and in the barrier layer and, moreover, that the iridium oxide in the support material acts as an oxygen evolution catalyst which oxidizes water to oxygen, this limiting potential of the anode in fuel depletion and so reducing the anode stress.

Advantageously, due to very good electrical conductivity with high degradation stability, the iridium oxide may take the form of a mixture or alloy with other metal oxides. Examples of metal oxides which may be present as a mixture or alloy with iridium oxide are RuO₂, SnO₂ and Ta₂O₅, resulting in mixed oxides of the molecular formulas IrₓRu(₁₋ₓ)O₂, IrₓSn(₁₋ₓ)O₂, and IrO₂—Ta₂O₅, respectively. However, iridium oxide should represent the main component, and ought therefore to represent a weight fraction, based on the total weight of the mixture or alloy, of more than 50 wt% and more particularly more than 75 wt% to ensure good OER activity and stability of the support material. Iridium oxide is preferably used substantially as pure oxide of molecular formula IrO₂. The iridium oxide here is disposed on the surface of the ceramic material, which it at least partly covers.

The resultant conductivity of the support material and the electrocatalyst obtained by platinum or platinum-alloy deposition may be demonstrated by powder conductivity measurements. Those skilled in the art may additionally demonstrate the electrical surface resistance within the electrode in, for example, a four-point measurement or directly in the fuel cell application through impedance measurement or measurement of polarization curves. The thermal treatment of the support material leads on the one hand to the crystallization of the iridium oxide to form a highly crystalline structure with very high electrical conductivity. On the other hand, the thermal treatment of the support material may lead to agglomeration to form larger particles of iridium oxide, which are therefore present separated from one another, meaning that there are not sufficient percolation pathways for electrons. The best trade-off between thermal treatment and metal quantity, which is still dependent on the nature of the ceramic material used, can be identified by those skilled in the art by suitable experimental planning within the above-defined limits.

For reasons of cost saving, according to a further advantageous example, the iridium oxide (based on metallic iridium) has a weight fraction with respect to the total weight of the support material of at most 35 wt% and more preferably of most 25 wt%. Low iridium weight fractions of this kind also ensure a sufficient layer thickness, in low iridium oxide loading (amount of iridium per unit geometric surface area), through the use of an inert component in the form of the ceramic material, and so they facilitate the possibility for these layers to be produced by known coating technologies such as knife coating, kiss-roll coating, slot-die coating, screen printing, gravure printing and the like. Even with these very low iridium contents, therefore, it is possible to achieve operationally reliable (and in particular also complete) coating of the ceramic material with iridium oxide.

Advantageously, moreover, the areal weight of iridium oxide in the barrier layer and/or in the anode, based on metallic iridium, is at most 0.05 mg_{Ir}/cm², preferably less than 0.03 mg_{Ir}/cm² and up to 0.01 mg_{Ir}/cm². In this way, with a low fraction of iridium oxide with respect to the total weight of the support material, it is possible to improve the producibility, with small amounts of iridium oxide also being advantageous for low production costs, since iridium is a very expensive precious metal.

In this connection it is also advantageous for a layer thickness of the anode which comprises the hydrogen oxidation catalyst to be 0.5 to 2 µm, for example. As a result, a sufficiently large catalyst layer thickness is obtained, which is advantageous for high performance capacity of the fuel cell MEA. In particular, a sufficiently large catalyst layer thickness prevents flooding of the anode by water under cold and damp operating conditions. To prevent flooding, it is possible where necessary to use additional hydrophobic additives in the anode, examples being perfluorinated polymers such as PTFE.

Advantageously, the ceramic material is a metal oxide and the metal is selected from the group consisting of titanium, niobium, tantalum, tungsten, silicon, zirconium, hafnium, tin or mixtures or alloys thereof. The above-recited metal oxides are notable for good acid stability and corrosion stability. Titanium oxide, niobium oxide and tungsten oxide are particularly preferred among them. Furthermore, the ceramic material may be doped with small amounts of other metals. In accordance with this disclosure, the ceramic material need not necessarily be electrically conductive since the electrical conductivity is provided through the use of iridium oxide. As a result it is also possible, furthermore, to achieve good electrical conductivity in the anode, in which particles of platinum and/or a platinum alloy are present on the support material, and hence a high power density of the fuel cell MEA can be obtained.

Advantageously, the hydrogen oxidation catalyst comprises particles of a platinum alloy, wherein one or more alloy elements are selected from the group consisting of ruthenium, rhodium, nickel, copper and iridium. The above alloy metals are notable for high corrosion stability and so also improve the oxidation stability of the anode comprising a platinum alloy.

To provide particularly high power of the fuel cell MEA in conjunction with very good cell reversal tolerance, the weight ratio of iridium in the support material to platinum in the anode is preferably less than or equal to 2:1, more preferably less than or equal to 1:1, very preferably less than or equal to 1:2 and especially preferably less than or equal to 1:3, with the weight fractions making up the weight ratio being based on the amounts with respect to metallic iridium and metallic platinum.

In the light of a costs saving, the areal weight of platinum in the anode (based on metallic Pt) is preferably at most 0.1 mg_{Pt}/cm², preferably at most 0.05 mg_{Pt}/cm² and more preferably at most 0.03 mg_{Pt}/cm².

To improve the stability of the support material and prevent degradation, the support material preferably has a core-shell structure, with the ceramic material forming the core and the iridium oxide the shell. Moreover, the iridium oxide may only partly cover the underlying ceramic material, and may form connected particle structures, producing electrically conductive channels within the layer. In an anode layer, the electrical connection may also derive from platinum particles which connect the iridium-covered surfaces.

For reasons of chemical inertness and of its hydrophobic properties, the polymeric binder of the barrier layer is preferably selected from fluorinated polymers and more particularly is polytetrafluoroethylene. It is also possible, furthermore, for an ion-conductive, polymeric binder to be used in the barrier layer. The binder thus affords the advantage that it promotes the OER reaction through the provision of water in the vicinity of the iridium oxide. Illustratively, a PFSA binder of a type the same as or similar to that in the anode may be used. In contrast to the anode, the barrier layer must be substantially free from platinum, especially in the vicinity of or at the interface with a gas diffusion layer. As a result, the carbon corrosion of the gas diffusion layer during cell reversal is prevented and hence a high cell reversal tolerance of the MEA is ensured.

The combination of a low amount of iridium oxide in the anode and/or the barrier layer of less than 0.05 mg_{Ir}/cm², preferably of less than 0.03 mg_{Ir}/cm² and up to 0.01 mg_{Ir}/cm², which is made possible through the use of a high fraction of ceramic material, with a high stability of the iridium oxide affords the advantage, furthermore, that only a very small amount of iridium oxide is broken down in the anode and/or in the barrier layer during anode potential cycling between low and high potentials and in the presence of hydrogen. Accordingly, contamination of the MEA by the breakdown of the iridium oxide is prevented. In particular there can be no passage of iridium in ionic form across to the cathode with consequent reduction in the performance capacity of the MEA. Furthermore, especially in the small amounts of iridium stated above, it is particularly important that the iridium exhibits high stability with respect to breakdown. Otherwise the iridium will break down rapidly on the anode by cycling and the cell reversal tolerance will be quickly lost.

The support material is obtained in particular by precipitation or deposition of an iridium precursor material on the ceramic material (conventional production) and subsequent calcining in air or an oxygen source at temperatures of more than 400° C., preferably more than 450° C. and more preferably more than 500° C. The temperature here is not to exceed 1000° C. and is preferably to be less than 750° C. and more preferably less than 650° C. to avoid excessive aggregation and a loss of specific surface area.

We also provide a fuel cell comprising a fuel cell membrane-electrode assembly as disclosed above. Due to the use of the fuel cell membrane-electrode assembly for the fuel cell, the fuel cell as well is notable for high power density, high long-term stability and the possibility of simple and reliable production, and, furthermore, for a high cell reversal tolerance.

Only the essential details are represented in the figures. All of the rest of the details are omitted for the sake of clarity.

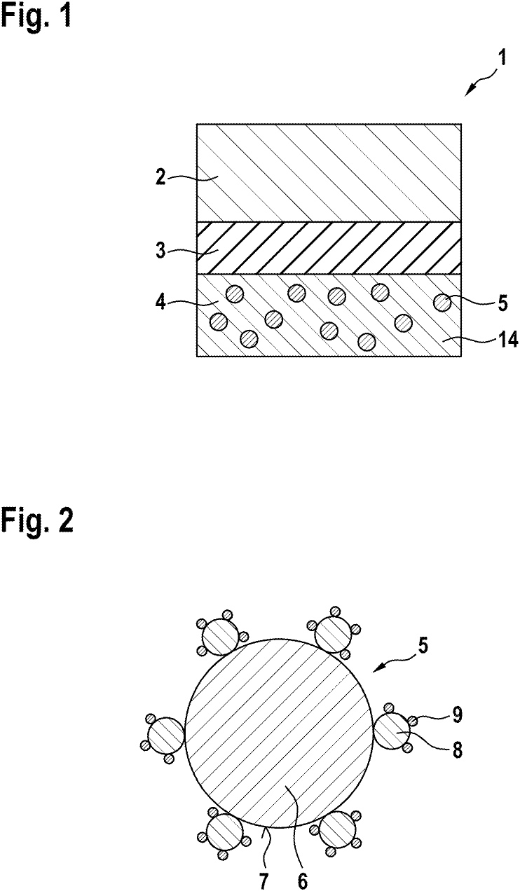

FIG. 1 shows in detail a fuel cell MEA 1 having a cathode 2, an anode 4 and a membrane 3 in between them. The membrane 3 is proton-conducting. The anode 4 comprises a support material 5 which is dispersed homogeneously in an ionomer 14.

The support material 5 is illustrated in detail in FIG. 2. The support material 5 takes the form of particles and comprises a ceramic material 6, which more particularly is a metal oxide, the metal being selected from the group consisting of titanium, niobium, tantalum, tungsten, silicon, zirconium, hafnium, tin or mixtures or alloys thereof. The ceramic material is notable for high chemical resistance, especially under acidic conditions. It is chemically inert, thus having no influence on the reactions in the fuel cell MEA 1, and is not necessarily electrically conducting.

Deposited on the surface 7 of the ceramic material 6 are particles of iridium oxide 8. The ceramic material 5 and the particles of iridium oxide 8 form the support material. Based on the total weight of the support material 5, a weight fraction of iridium oxide 8 (this value being based on the fraction of metallic iridium) is at most 50 wt%, preferably at most 35 wt% and more preferably at most 25 wt%. The particles of iridium oxide 8 are notable for good electrical conductivity, this being important for the performance capacity and the cell reversal tolerance of the fuel cell MEA 1. In the fuel cell MEA 1 a high cell reversal tolerance is achieved in particular through the omission of carbon materials in the anode and through the effect, moreover, of the iridium oxide 8 as an oxygen evolution catalyst which oxidizes water to oxy-gen, so limiting the potential of the anode in fuel depletion and hence reducing the anode stress.

Because of the high electrical conductivity of the particles of iridium oxide 8, it is possible accordingly to do without customary electrically conductive additives such as carbon-containing materials, for example, such as carbon black and graphite. The anode 4 thus contains no carbon material. In other words, no carbon-containing material is added to the anode 4. The support material 5 is notable for a high stability toward corrosion, and so during the operation of the fuel cell there is no degradation due to oxidative processes. As a result, a high long-term stability with very good cell reversal tolerance is also achieved.

In the example of the fuel cell MEA 1 shown in FIGS. 1 and 2, the support material 5 is present in the anode 4. The anode 4 further comprises at least one ionomer 14 and a hydrogen oxidation catalyst 9, the hydrogen oxidation catalyst 9 comprising particles of platinum and/or a platinum alloy, which in this example are disposed, for example, on the support material 5. Particularly suitable alloy metals here are selected from the group consisting of ruthenium, rhodium, nickel, copper and iridium.

The areal weight of platinum (based on metallic platinum) in the anode 4 is more particularly at most 0.1 mg_{Pt}/cm², preferably at most 0.05 mg_{Pt}/cm² and more preferably at most 0.03 mg_{Pt}/cm². Even through these low amounts of platinum it is possible to achieve a very good power density of the fuel cell MEA 1.

The weight ratio of iridium oxide 8 in the support material 5 to platinum in the anode 4 (based on metallic iridium and metallic platinum) is preferably also less than or equal to 2:1, more preferably less than or equal to 1:1, more preferably still less than or equal to 1:2, and especially preferably less than or equal to 1:3.

The above-described fuel cell MEA 1 is notable for a high cell reversal tolerance while at the same time having a high power density, high long-term stability and capacity for simple and reliable production.

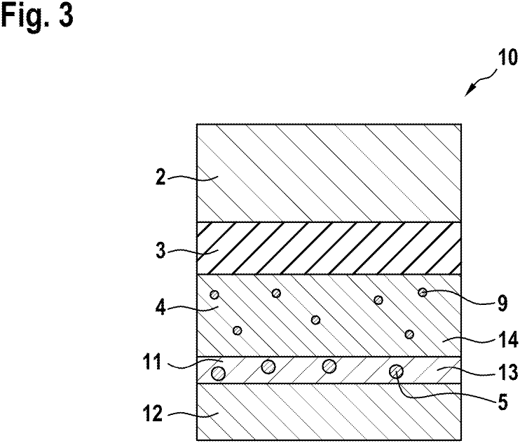

FIG. 3 shows a fuel cell MEA 10 according to a second example. The fuel cell MEA 10 again has a cathode 2, a membrane 3 and an anode 4. In addition, however, there are also a barrier layer 11 and a gas diffusion layer 12 present.

The anode 4 in this example contains no support material (but may contain one, being formed, for example, by the support material described above), but again it comprises an ionomer 14 and a hydrogen oxidation catalyst 9 comprising particles of platinum and/or a platinum alloy. Particularly suitable alloy metals are again selected from the group consisting of ruthenium, rhodium, nickel, copper and iridium.

The areal weight of platinum in the anode 4 is at most 0.1 mg_{Pt}/cm², preferably at most 0.05 mg_{Pt}/cm² and more preferably at most 0.03 mg_{Pt}/cm². As a result of these low amounts of platinum it is possible to achieve a very good power density in the fuel cell MEA 10 as well.

To improve the cell reversal tolerance of the fuel cell MEA 10, the barrier layer 11 is provided, and disposed on the anode side of the fuel cell MEA 10 between the anode 4 and the gas diffusion layer 12. The barrier layer 11 comprises a support material 5 and additionally at least one polymeric binder 13, which advantageously contains PTFE.

The support material 5 may have the same example as the support material from FIG. 2, but without the hydrogen oxidation catalyst 9. Accordingly the support material 5 is particulate and comprises a particulate ceramic material 6 with particles of iridium oxide 8 disposed on the surface 7 thereof. The areal weight of iridium oxide 8 (this value is based on the metallic iridium) in the barrier layer 11 is at most 0.05 mg_{Ir}/cm² and preferably less than 0.03 mg_{Ir}/cm².

In the fuel cell MEA 10 as well it is possible to achieve very good cell reversal tolerance through the use of the support material 5 in the barrier layer 11.

As well as the written description above, reference is hereby made, for supplementary disclosure, explicitly to the graphical representations in FIGS. 1 to 3.

1-10. (canceled)

11. A fuel cell membrane-electrode assembly comprising:
a support material comprising a ceramic material and iridium oxide, wherein
a weight fraction of iridium oxide, based on metallic iridium, with respect to the total weight of the support material, is at most 50 wt%, and
the support material has a weight loss of less than 3 wt%, based on the weight fraction of the iridium oxide on exposure of the support material to a 3.3 vol% hydrogen stream in argon at a temperature of 80° C. for 12 hours.

12. The fuel cell membrane-electrode assembly as claimed in claim 11, wherein the support material is present in an anode of the fuel cell membrane-electrode assembly and the anode further comprises at least one ionomer and a hydrogen oxidation catalyst, the hydrogen oxidation catalyst comprising particles of platinum and/or a platinum alloy which are disposed on the support material, and/or
the support material is present in a barrier layer disposed between an anode and a gas diffusion layer of the fuel cell membrane-electrode assembly, the barrier layer further comprising at least one polymeric binder.

13. The fuel cell membrane-electrode assembly as claimed in claim 11, wherein the iridium oxide is present in a mixture or alloy with other metal oxides, and/or
the weight fraction of iridium oxide, based on metallic iridium, with respect to the total weight of the support material, is at most 35 wt%, or at most 25 wt%.

14. The fuel cell membrane-electrode assembly as claimed in claim 12, wherein the areal weight of iridium oxide, based on metallic iridium, in the barrier layer and/or the anode is at most 0.05 mg_{Ir}/cm² or less than 0.03 mg_{Ir}/cm².

15. The fuel cell membrane-electrode assembly as claimed in claim 11, wherein the ceramic material is a metal oxide and the metal is selected from the group consisting of titanium, niobium, tantalum, tungsten, silicon, zirconium, hafnium, tin and mixtures or alloys thereof.

16. The fuel cell membrane-electrode assembly as claimed in claim 12, wherein the hydrogen oxidation catalyst comprises particles of a platinum alloy, and one or more alloy metals are selected from the group consisting of ruthenium, rhodium, nickel, copper and iridium.

17. The fuel cell membrane-electrode assembly as claimed in claim 11, wherein a weight ratio of iridium oxide in the support material to platinum in the anode, each based on metallic iridium and on metallic platinum, respectively, is less than or equal to 2:1.

18. The fuel cell membrane-electrode assembly as claimed in claim 11, wherein an areal weight of platinum in the anode is at most 0.1 mg_{Pt}/cm², and
the support material has a core-shell structure.

19. The fuel cell membrane-electrode assembly as claimed in claim 12, wherein the polymeric binder is selected from fluorinated polymers and is polytetrafluorethylene, and/or
the anode and/or the barrier layer are free from carbon and carbon-containing compounds.

20. A fuel cell comprising the fuel cell membrane-electrode assembly as claimed in claim 11.
